(19) United States
(12) Patent Application Publication
(10) Pub. No.: US 2020/0304563 A1
(43) Pub. Date: Sep. 24, 2020

(54) METHOD FOR ACCESSING NETWORK BY INTERNET OF THINGS DEVICE, APPARATUS, AND SYSTEM

(71) Applicant: HUAWEI TECHNOLOGIES CO., LTD., Shenzhen (CN)

(72) Inventors: Zhigao CHENG, Shenzhen (CN); Rong LIU, Shenzhen (CN)

(21) Appl. No.: 16/899,362

(22) Filed: Jun. 11, 2020

Related U.S. Application Data
(63) Continuation of application No. PCT/CN2018/121089, filed on Dec. 14, 2018.

(30) Foreign Application Priority Data
Dec. 28, 2017 (CN) 201711453817.4

(51) Int. Cl. H04L 29/08; H04L 29/06; H04W 88/16; H04L 12/28

(52) U.S. Cl. CPC H04L 67/10; H04L 65/1073; H04L 63/0272; H04L 12/2856; H04W 88/16

(57) ABSTRACT

This application provides a method for accessing a network by an internet of things device, an apparatus, and a system. The system includes a registration server and a first cloud gateway server. The internet of things device obtains, by using a connection to the registration server, an address of the first cloud gateway server corresponding to the internet of things device from the registration server, and establishes a connection to the first cloud gateway server. Because the internet of things device obtains, by using a unified registration server, the address of the first cloud gateway server required for accessing the network, the address of the cloud gateway server does not need to be configured on the internet of things device. This reduces production complexity of the internet of things device.

### CROSS-REFERENCE TO RELATED APPLICATIONS

This application is a continuation of International Application No. PCT/CN2018/121089, filed on Dec. 14, 2018, which claims priority to Chinese Patent Application No. 201711453817.4, filed on Dec. 28, 2017. The disclosures of the aforementioned applications are hereby incorporated by reference in their entireties.

### TECHNICAL FIELD

This application relates to the field of IT technologies, and in particular, to a method for accessing a network by an internet of things device, an apparatus, and a system.

### BACKGROUND

Internet of things (IoT) is an important part of new-generation information technologies and also an important development phase in the information era. The internet of things is the internet on which things are connected, which has two meanings: First, a core and a basis of the internet of things are still the internet, and the internet of things is a network extended and expanded on a basis of the internet. Second, the internet of things is extended and expanded between any things to perform information exchange and communication. The internet of things is widely used in network convergence by using communications sensing technologies such as intelligent sensing and identification technologies. Therefore, the internet of things is also referred to as the third wave of world information industry development following computers and the internet.

An internet of things device has a communication address on the network and is connected to the internet of things by using a cloud gateway server. An address (an IP address or a domain name) of the cloud gateway server connected to the internet of things device may need to be changed because the internet of things device is installed, moved, or tested, or the cloud gateway server is adjusted. Therefore, the address of the cloud gateway server corresponding to the internet of things device needs to be manually reconfigured. In addition, the address of the cloud gateway server may be incorrectly configured due to mis-operations. As a result, the internet of things device fails to access the network.

### SUMMARY

Embodiments of this application provide a method for accessing a network by an internet of things device, an apparatus, and a system, to resolve a problem that the internet of things device fails to access the network because an address of a cloud gateway server corresponding to the internet of things device is incorrectly configured due to manual configuration of the address of the cloud gateway server.

Technical solutions provided in the embodiments of this application are as follows.

According to a first aspect, an internet of things system is provided. The internet of things system includes a registration server and a plurality of cloud gateway servers, and there is a communication connection between the registration server and an internet of things device.

The registration server configures a correspondence between an identifier of the internet of things device and an address of one of the plurality of cloud gateway server, and receives, through the communication connection, a first server address query request sent by the internet of things device, where the first server address query request carries the identifier of the internet of things device. The registration server queries, based on the correspondence, an address of a first cloud gateway server corresponding to the identifier of the internet of things device, and returns a first server address query response to the internet of things device, where the first server address query response carries the address of the first cloud gateway server, and the address of the first cloud gateway server is used to instruct the internet of things device to establish a communication connection to the first cloud gateway server.

The first cloud gateway server is adapted to establish the communication connection to the internet of things device.

In this embodiment of the present application, the correspondence between the identifier of the internet of things device and the address of the cloud gateway server is recorded on the registration server. The internet of things device obtains, by using the connection to the registration server, an address of a cloud gateway server corresponding to the internet of things device, and establishes a connection to the cloud gateway server. Because the internet of things device obtains, by using a unified registration server, the address of the cloud gateway server required for accessing the network, the address of the cloud gateway server does not need to be configured on the internet of things device. This avoids an access failure that may be caused by incorrect manual configuration of the address of the cloud gateway server, and reduces production complexity of the internet of things device.

Further, the registration server is adapted to update the correspondence, where an updated cloud gateway server corresponding to the internet of things device is a second cloud gateway server in the plurality of cloud gateway servers.

The first cloud gateway server is further adapted to send a notification message to the internet of things device, where the notification message is used to indicate that a cloud gateway server corresponding to the internet of things device changes.

The registration server is further adapted to receive a second server address query request sent by the internet of things device, where the second server address query request carries the identifier of the internet of things device.

The registration server is further adapted to query the updated correspondence based on the identifier of the internet of things device, and determine that the updated cloud gateway server corresponding to the internet of things device is the second cloud gateway server.

The registration server is further adapted to return a second server address query response to the internet of things device, where the second server address query response carries an address of the second cloud gateway server, and the address of the second cloud gateway server is used to instruct the internet of things device to establish a communication connection to the second cloud gateway server.

The second cloud gateway server is adapted to establish the communication connection to the internet of things device.

The internet of things system further includes at least one storage client, and an address of the registration server is configured on the storage client. Because the address of the registration server is configured on the internet of things device, the internet of things device may establish the communication connection to the registration server, and obtain, from the registration server, the address of the cloud gateway server required for accessing the network. In this way, the address of the cloud gateway server does not need to be configured on the internet of things device. This reduces production complexity of the internet of things device.

When the cloud gateway server connected to the internet of things device changes, an address of a new cloud gateway server does not need to be manually configured. This avoids a problem of incorrect configuration that may be caused by manual processing. In this embodiment of the present application, because an address of an updated second cloud gateway server is recorded on the registration server, when the first cloud gateway server is disabled and the internet of things device cannot access the network, because the registration server records the address of the second cloud gateway server, the internet of things device may obtain the address of the second cloud gateway server from the registration server, and access the network by using the second cloud gateway server.

According to a second aspect, a method for accessing a network by an internet of things device is provided. In the method according to the second aspect, the internet of things device and a registration server perform functions in the foregoing internet of things system.

According to a third aspect, a registration server is provided, where the registration server includes:

a configuration unit, adapted to configure a correspondence between an identifier of an internet of things device and an address of a cloud gateway server;

a connection establishment unit, adapted to establish a communication connection to the internet of things device, where an address of the registration server is configured on the internet of things device;

a receiving unit, adapted to receive, through the communication connection, a first server address query request sent by the internet of things device, where the first server address query request carries the identifier of the internet of things device;

a query unit, adapted to query, based on the correspondence configured by the configuration unit, an address of a first cloud gateway server corresponding to the identifier of the internet of things device; and

a sending unit, adapted to return a first server address query response to the internet of things device, where the first server address query response carries the address of the first cloud gateway server obtained by the query unit through query, and the address of the first cloud gateway server is used to instruct the internet of things device to establish a communication connection to the first cloud gateway server.

The configuration unit is further adapted to update the correspondence, where an updated cloud gateway server corresponding to the internet of things device is a second cloud gateway server in a plurality of cloud gateway servers.

The receiving unit is further adapted to receive a second server address query request sent by the internet of things device, where the second server address query request carries the identifier of the internet of things device.

The query unit is further adapted to query the updated correspondence based on the identifier of the internet of things device, and determine that the updated cloud gateway server corresponding to the internet of things device is the second cloud gateway server.

The sending unit is further adapted to return a second server address query response to the internet of things device, where the second server address query response carries an address of the second cloud gateway server obtained by the query unit through query, and the address of the second cloud gateway server is used to instruct the internet of things device to establish a communication connection to the second cloud gateway server.

According to a fourth aspect, an embodiment of the present application further provides a registration server, where the registration server is a physical server and has a function of implementing the registration server in the foregoing aspects. The function may be implemented by hardware, or may be implemented by hardware executing corresponding software. The hardware or the software includes one or more modules corresponding to the foregoing functions.

In one embodiment, the registration server includes a transceiver and a processor, where the processor is adapted to invoke a set of program code, to execute the method according to the second aspect.

According to a fifth aspect, a computer storage medium is provided, and is adapted to store a computer software instruction used by the registration server in the foregoing aspects. The computer software instruction includes a program designed for executing the foregoing aspects.

### BRIEF DESCRIPTION OF DRAWINGS

FIG. 1 is a schematic structural diagram of an internet of things system according to an embodiment of the present application;

FIG. 2 is a schematic flowchart of a method for accessing a network by an internet of things device according to an embodiment of the present application;

FIG. 3 is a schematic flowchart of another method for accessing a network by an internet of things device according to an embodiment of the present application;

FIG. 4 is a schematic diagram of a logical structure of a registration server according to an embodiment of the present application; and

FIG. 5 is a schematic diagram of a hardware structure of a registration server according to an embodiment of the present application.

### DESCRIPTION OF EMBODIMENTS

The following further describes this application with reference to accompanying drawings.

There may be a large quantity of widely distributed cloud gateway servers in the internet of things. In a manufacturing process of an internet of things device, an address of a cloud gateway server connected when the internet of things device is initialized cannot be determined. When the address of the cloud gateway server of the internet of things device is manually configured, the internet of things device may fail to access a network due to incorrect manual configuration. In addition, when an entire internet of things device connected to a cloud gateway server is switched to another cloud gateway server, the original cloud gateway server cannot stop running before the switching of the internet of things device is completed.

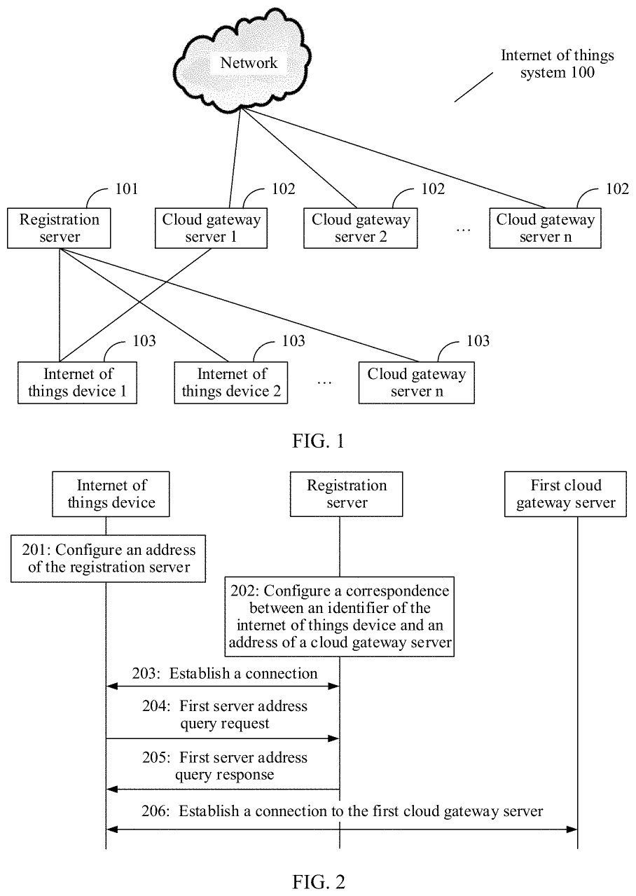

FIG. 1 is a schematic structural diagram of an internet of things system according to an embodiment of the present application. The internet of things system 100 includes a registration server 101 and a plurality of cloud gateway servers 102. An internet of things device 103 accesses internet of things by using the cloud gateway servers 102.

When the internet of things device 103 is manufactured or before the internet of things device 103 is used for the first time, an address of the registration server 101 is configured on the internet of things device 103. The address of the registration server 101 may be an IP address or a domain name.

The registration server 101 stores a correspondence between an identifier of the internet of things device 103 and an address of the cloud gateway server 102. The correspondence may be configured by an internet of things provider, or may be configured by a user by logging in to a portal screen externally presented by the registration server. The identifier of the internet of things device 103 recorded on the correspondence may uniquely identify an internet of things device.

As shown in FIG. 2, an embodiment of the present application provides a method for accessing a network by an internet of things device, and the method includes the following operations.

Operation 201: Configure an address of a registration server in the internet of things device.

Operation 202: Configure, on the registration server, a correspondence between an identifier of the internet of things device and an address of a cloud gateway server.

Operation 203: After being started, the internet of things device establishes a communication connection to the registration server based on the configured address of the registration server.

Operation 204: The internet of things device sends a first server address query request to the registration server, where the first server address query request carries the identifier of the internet of things device.

Operation 205: After receiving the first server address query request, the registration server queries the recorded correspondence, determines, based on the identifier of the internet of things device, an address of a first cloud gateway server corresponding to the internet of things device, and returns a first server address query response to the internet of things device, where the first server address query response carries the determined address of the first cloud gateway server corresponding to the internet of things device.

Operation 206: The internet of things device receives the first server address query response, obtains the address of the first cloud gateway server, and establishes a connection to the first cloud gateway server, to access internet of things.

It should be noted that the operations 201 and 202 are not subject to a particular sequence, and the operation 202 may be performed before the operation 201.

In this embodiment of the present application, the correspondence between the identifier of the internet of things device and the address of the cloud gateway server is recorded on the registration server. The internet of things device obtains, by using the connection to the registration server, an address of a cloud gateway server corresponding to the internet of things device, and establishes a connection to the cloud gateway server. Because the internet of things device obtains, by using a unified registration server, the address of the cloud gateway server required for accessing the network, the address of the cloud gateway server does not need to be configured on the internet of things device. This avoids an access failure that may be caused by incorrect manual configuration of the address of the cloud gateway server, and reduces production complexity of the internet of things device.

The embodiment shown in FIG. 2 provides the method for accessing a network by an internet of things device for the first time. Further, because the internet of things device may need to change the address of the cloud gateway server connected to the internet of things device when the cloud gateway server is installed, moved, tested, or adjusted, this embodiment of the present application provides a method for accessing a network by an internet of things device after the address of the cloud gateway server of the internet of things device changes.

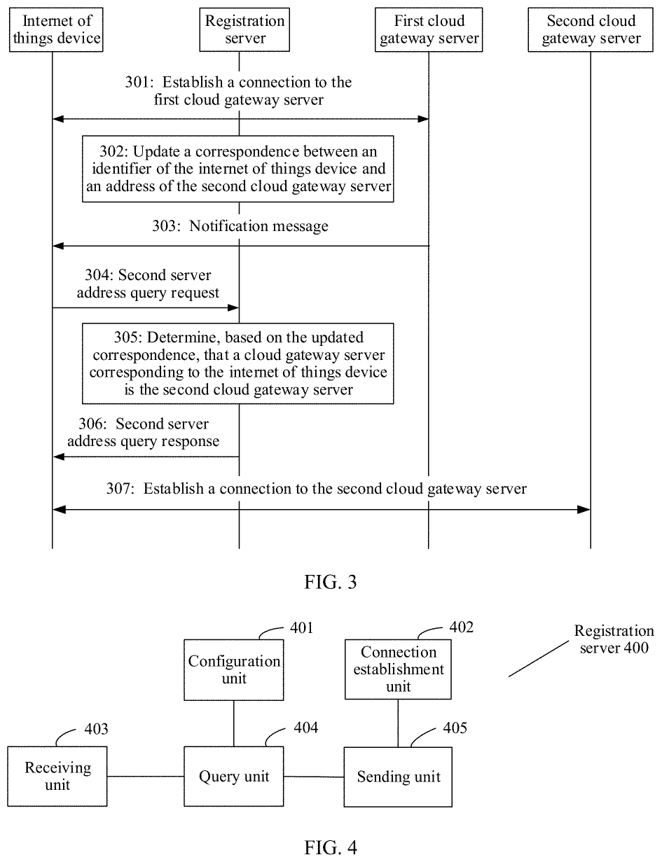

FIG. 3 shows another method for accessing a network by an internet of things device according to an embodiment of the present application. The method includes the following operations.

Operation 301: The internet of things device establishes a connection to a first cloud gateway server, and accesses the network by using the first cloud gateway server.

Operation 302: A registration server updates a cloud gateway server corresponding to the internet of things device to a second cloud gateway server, and updates a correspondence between an identifier of the internet of things device and an address of the second cloud gateway server.

Operation 303: The first cloud gateway server delivers a notification message to the internet of things device, where the notification message is used to instruct the internet of things device to update an address of the cloud gateway server.

In one embodiment, the notification message may be an access reject message, and the access reject message is used to indicate that the first cloud gateway server rejects the internet of things device to access the network.

Operation 304: The internet of things device receives the notification message, determines that an accessed cloud gateway server needs to be updated, and sends a second server address query request to the registration server, where the second server address query request carries the identifier of the internet of things device.

Operation 305: The registration server receives the second server address query request, determines, based on the updated correspondence, that the cloud gateway server corresponding to the internet of things device is the second cloud gateway server, and obtains the address of the second cloud gateway server.

Operation 306: The registration server returns a second server address query response to the internet of things device, where the second server address query response carries the address of the second cloud gateway server.

Operation 307: The internet of things device receives the server query response, establishes a connection to the second cloud gateway server based on the address of the second cloud gateway server, and accesses the network by using the second cloud gateway server.

It should be noted that the operations 301 and 302 are not subject to a particular sequence, and the operation 302 may be performed before the operation 301.

As described above, when the internet of things device accesses the network, the address of the cloud gateway server connected to the internet of things device is dynamically obtained by the internet of things device by accessing the registration server. In this way, when the internet of things device runs for the first time or fails to connect to the cloud gateway server, the internet of things device can obtain a latest address of the cloud gateway server by accessing the registration server, to ensure that the internet of things device can successfully access internet of things. Because a unified registration server is used, configuration of the internet of things device is simpler. Only an address of the registration server needs to be configured, and the address of the cloud gateway server does not need to be configured on the internet of things device. This reduces production complexity of the internet of things device. Further, when the cloud gateway server connected to the internet of things device changes, an address of a new cloud gateway server does not need to be manually configured. This avoids a problem of incorrect configuration that may be caused by manual processing. Further, in the prior art, when an entire internet of things device connected to the cloud gateway server is switched to another cloud gateway server, the original cloud gateway server cannot stop running before the switching is completed. In this embodiment of the present application, an address of an updated second cloud gateway server is recorded on the registration server. When the first cloud gateway server is disabled and the internet of things device cannot access the network, because the registration server records the address of the second cloud gateway server, the internet of things device may obtain the address of the second cloud gateway server from the registration server, and access the network by using the second cloud gateway server.

Corresponding to the foregoing embodiments, an embodiment of the present application further provides a registration server 400, and the registration server 400 includes:

a configuration unit 401, adapted to configure a correspondence between an identifier of an internet of things device and an address of a cloud gateway server;

a connection establishment unit 402, adapted to establish a communication connection to the internet of things device, where an address of the registration server is configured on the internet of things device;

a receiving unit 403, adapted to receive, through the communication connection, a first server address query request sent by the internet of things device, where the first server address query request carries the identifier of the internet of things device;

a query unit 404, adapted to query, based on the correspondence configured by the configuration unit 401, an address of a first cloud gateway server corresponding to the identifier of the internet of things device; and

a sending unit 405, adapted to return a first server address query response to the internet of things device, where the first server address query response carries the address of the first cloud gateway server obtained by the query unit 404 through query, and the address of the first cloud gateway server is used to instruct the internet of things device to establish a communication connection to the first cloud gateway server.

The configuration unit 401 is further adapted to update the correspondence, where an updated cloud gateway server corresponding to the internet of things device is a second cloud gateway server in a plurality of cloud gateway servers.

The receiving unit 403 is further adapted to receive a second server address query request sent by the internet of things device, where the second server address query request carries the identifier of the internet of things device.

The query unit 404 is further adapted to query the updated correspondence based on the identifier of the internet of things device, and determine that the updated cloud gateway server corresponding to the internet of things device is the second cloud gateway server.

The sending unit 405 is further adapted to return a second server address query response to the internet of things device, where the second server address query response carries an address of the second cloud gateway server obtained by the query unit 404 through query, and the address of the second cloud gateway server is used to instruct the internet of things device to establish a communication connection to the second cloud gateway server.

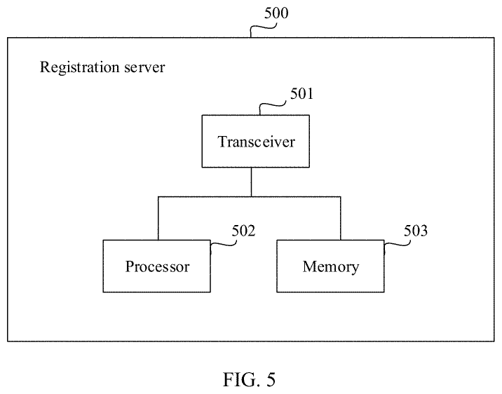

Based on a same invention concept, referring to FIG. 5, an embodiment of this application further provides a schematic diagram of a hardware structure of a registration server. The registration server 500 includes a transceiver 501, a processor 502, and a memory 503. The transceiver 501 and the memory 503 are connected to the processor 502. It should be noted that a connection manner between parts shown in FIG. 5 is merely a possible example. Alternatively, the transceiver 501 and the memory 503 are connected to the processor 502, and the transceiver 501 is not connected to the memory 503. Alternatively, another possible connection manner may be used.

The memory 503 stores a group of programs, and the processor 502 is adapted to invoke the programs stored in the memory 503, to perform the functions of the registration server in the internet of things system and the method for accessing a network by an internet of things device that are shown in FIG. 1 to FIG. 4.

In FIG. 5, the processor 502 may be a central processing unit (CPU), a network processor (NP), or a combination of the CPU and the NP.

The memory 501 may include a volatile memory, for example, a random-access memory (RAM). The memory 501 may also include a non-volatile memory, for example, a flash memory, a hard disk drive (HDD), or a solid-state drive (SSD). The memory 401 may further include a combination of the foregoing types of memories.

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the protection scope of the technical solutions of the embodiments of the present application.

What is claimed is:

1. An internet of things system comprising:
a registration server; and
a first cloud gateway server, wherein the registration server is adapted to receive, through a communication connection between the registration server and an internet of things device, a first server address query request sent by the internet of things device;
wherein, the registration server is further adapted to query, based on a correspondence between the internet of things device and the first cloud gateway server, an address of the first cloud gateway server corresponding to the internet of things device, and return the address of the first cloud gateway server to the internet of things device.

2. The system according to claim 1, wherein the first server address query request carries an identifier of the internet of things device.

3. The system according to claim 2, wherein
the registration server is further adapted to configure the correspondence, wherein the correspondence is a correspondence between the identifier of the internet of things device and the address of the cloud gateway server.

4. The system according to claim 1, wherein
the address of the first cloud gateway server is used to instruct the internet of things device to establish a communication connection to the first cloud gateway server.

5. The system according to claim 1, wherein
the first cloud gateway server is adapted to establish the communication connection to the internet of things device.

6. The system according to claim 1, wherein
the registration server is further adapted to return a first server address query response to the internet of things device, wherein the first server address query response carries the address of the first cloud gateway server.

7. The system according to claim 1, further comprising:
a second cloud gateway server, wherein, the registration server is further adapted to update the correspondence, wherein an updated cloud gateway server corresponding to the internet of things device is the second cloud gateway server; and
wherein, the first cloud gateway server is further adapted to send a notification message to the internet of things device, wherein the notification message is used to indicate that a cloud gateway server corresponding to the internet of things device changes.

8. The system according to claim 6, wherein
the registration server is further adapted to receive a second server address query request sent by the internet of things device; and
the registration server is further adapted to query, based on the updated correspondence between the internet of things device and the second cloud gateway server, an address of the second cloud gateway, and return the address of the second cloud gateway server to the internet of things device.

9. A method for accessing a network by an internet of things device, the method comprising:
receiving, by a registration server through a communication connection between the registration server and an internet of things device, a first server address query request sent by the internet of things device; and
querying, by the registration server based on a correspondence between the internet of things device and a first cloud gateway server, an address of the first cloud gateway server corresponding to the internet of things device, and returning the address of the first cloud gateway server to the internet of things device.

10. The method according to claim 9, wherein the first server address query request carries an identifier of the internet of things device.

11. The method according to claim 9, the method further comprising:
configuring, by the registration server, the correspondence, wherein the correspondence is a correspondence between the identifier of the internet of things device and the address of the cloud gateway server.

12. The method according to claim 9, the method further comprising:
establishing, by the registration server, the communication connection to the internet of things device, wherein an address of the registration server is configured on the internet of things device.

13. The method according to claim 9, the method further comprising:
returning a first server address query response to the internet of things device, wherein the first server address query response carries the address of the first cloud gateway server, and the address of the first cloud gateway server is used to instruct the internet of things device to establish a communication connection to the first cloud gateway server.

14. The method according to claim 9, wherein after the internet of things device establishes the communication connection to the first cloud gateway server, the method further comprising:
updating, by the registration server, the correspondence, wherein an updated cloud gateway server corresponding to the internet of things device is a second cloud gateway server.

15. A registration server comprising:
a processor; and
a computer-readable storage medium storing a program to be executed by the processor, the program including instructions that when executed by the processor cause the processor to perform operations comprising:
receiving, through a communication connection, a first server address query request sent by an internet of things device; and
querying, based on a correspondence between the internet of things device and the first cloud gateway server, an address of a first cloud gateway server corresponding to the internet of things device, and return the address of the first cloud gateway server to the internet of things device.

16. The registration server according to claim 15, wherein the program further includes instructions for execution by the processor including:
establishing the communication connection to the internet of things device.

17. The registration server according to claim 15, wherein the program further includes instructions for execution by the processor including:
updating the correspondence, wherein an updated cloud gateway server corresponding to the internet of things device is a second cloud gateway server.

18. An internet of things device comprising:
a processor; and
a computer-readable storage medium storing a program to be executed by the processor, the program including instructions that when executed by the processor cause the processor to perform operations comprising:
sending a first server address query request to a registration server through a communication connection between the internet of things device and the registration server;
receiving an address of a first cloud gateway server from the registration server; and
establishing an communication connection to the first cloud gateway server.

19. The internet of things device according claim 18, wherein the program further includes instructions for execution by the processor including:
receiving a notification message from the first cloud gateway server, wherein the notification message is used to indicate that a cloud gateway server corresponding to the internet of things device changes.

20. The internet of things device according claim 19, wherein the program further includes instructions for execution by the processor including:
sending a second server address query request to the registration server through the communication connection;
receiving an address of a second cloud gateway server from the registration server; and
establishing an communication connection to the second cloud gateway server.
